(19) United States
(12) Patent Application Publication
(10) Pub. No.: US 2002/0137394 A1
(43) Pub. Date: Sep. 26, 2002

(54) ROTARY-PLUG WALL LAMP

(75) Inventor: Ron Chung Li, Taipei (TW)

Correspondence Address: DOUGHERTY & TROXELL, 5205 Leesburg Pike, Suite 1404, Falls Church, VA, 22041, US

(73) Assignee: Long-Beam Enterprise Co., Ltd.

(21) Appl. No.: 09/813,311

(22) Filed: Mar. 21, 2001

(51) Int. Cl. H01R 25/00

(52) U.S. Cl. 439/647

(57) ABSTRACT

A rotary-plug wall lamp, which comprises a socket body having a seat hole to be mounted with a ring-shaped copper piece and a contact copper piece riveted in place; the outer ends of the two contact copper pieces are in contact with the power copper pins of the rotary disk respectively; the inner edge thereof is in contact with the contact points of the circuit board; the rotary disk and the socket body are connected electrically through a shaft contact point therein and a ring-shaped contact point so as to supply power for the wall lamp, which can be turned freely within an angle of 270 degrees.

### BACKGROUND OF THE INVENTION

1. Field of the Invention

This invention relates to a wall lamp, and particularly to a rotary-plug wall lamp.

2. Description of the Prior Art

In the conventional wall lamp, the two copper plugs and the socket body are made into one piece; such copper plugs are usually limited with the installation direction of the power outlet, i.e., an ornament on the upper end or outer end of the socket body is unable to set upwards as it should.

There is a conventional plug structure, which was used in a liquid type of mosquito smudge heated with an electric heater. The heater is mounted in an upper body portion and a lower body portion; each of the two body portions has semi-circular opening. A plug base has two copper plugs and a disk-shaped member, which is fitted in an opening formed with the two semi-circular openings. The plug base and body portion can be turned at an angle of 90 degrees relatively. When the liquid type of mosquito smudge is inserted in a power outlet on a wall, the plug structure would not affected by the position of the power outlet so as to maintain the mosquito smudge always in vertical position.

In a conventional art as mentioned in U.S. Pat. No. 5,683,254, the swivel plug structure with a bulb socket, in which the bottom surface of the socket body has two symmetrical semi-circular slots; one end of each semi-circular slot has a through slot, while other end of the semi-circular slot has a stop flange. One end of the swivel base has two copper plugs, while the other end thereof has two symmetrical hook members on the disk member thereof; the hook members are to be plugged through two through slots respectively in the socket body so as to have the swivel base and the socket body connected together. An outer cover has two symmetrical stop posts, of which the lower ends are set on the semi-circular slot nearing the through slots respectively; the stop post is used for stopping of, and limiting the turning angle of the hook member.

### SUMMARY OF THE INVENTION

The prime object of the present invention is to provide a rotary-plug wall lamp, in which the center of the socket body has a seat hole for receiving a rotary disk to be turned at a limited angle; the power copper pins mounted on the rotary disk are in contact with a contact copper piece and a ring-shaped copper piece through angle plates respectively; after the wall lamp is plugged in a power receptacle on wall, the socket body thereof can be turned freely within an angle of 270 degrees.

Another object of the present invention is to provide a rotary-plug wall lamp, in which the center of the socket body of the wall lamp is furnished with a seat hole, of which the outer edge is furnished with symmetrical fastening flanges for holding the rotary disk in place; the center thereof and the inner wall plate in the seat hole are connected together by means of a hollow rivet so as to have the power copper pins and the contact copper pieces in the socket body maintained close contact; when the rotary disk turns along the round surface of the seat hole, the contact points between them would not loosen or separate from each other.

Still another object of the present invention is to provide a rotary-plug wall lamp, in which the center of the socket body of the wall lamp has a seat hole, and the inner wall surface thereof has a round channel and a through rectangular hole for receiving the round contact plate of the ring-shaped copper piece, and having a flat plate extended from the stop plate of the round contact plate passed through and reached the other end of the socket body; the round contact plate and another power copper pin can be in close and flexible contact upon the rotary disk turning at a given angle.

A further object of the present invention is to provide a rotary-plug wall lamp, in which the round channel of the seat hole in the socket body is mounted with a ring-shaped copper piece, and the inner edge of the round contact plate of the ring-shaped copper piece has a stop plate to be placed across the guide channel; a positioning block furnished in the rotary disk moves along the guide channel on the wall surface of the socket body; the positioning block will be stopped by the stop plate so as to limit the same to turn within an angle of 270 degrees.

A still further object of the present invention is to provide a rotary-plug wall lamp, in which the two power copper pins of the rotary disk are in contact with a contact piece riveted in the center thereof and a ring-shaped copper piece respectively; the flat plates on the other ends of the center contact copper piece and the ring-shaped copper piece pass through the wall surface of the seat hole respectively, and extend into the positioning channels respectively so as to have the flat plates contacted with the contact points of the circuit board firmly, and to supply the circuit board with power.

Yet another object of the present invention is to provide a rotary-plug wall lamp, in which the power copper pins of the rotary disk, the contact copper pieces in the seat hole of the socket body, the circuit board and the bulb-contact copper pieces are all mounted in place by means of plug connection, and the copper pieces are in contact each other in a flexible and good conduct condition.

### BRIEF DESCRIPTION OF THE DRAWINGS

FIG. 1 is a perspective view of the present invention, showing one of the rotary direction of the power copper pin.

FIG. 2 is a perspective view of the present invention, showing another rotary direction of the power copper pin.

FIG. 3 is a disassembled view of the present invention, showing the disassembled relation between the socket casing and the socket body.

FIG. 4 is a disassembled view of the present invention, showing the disassembled relation between the circuit board and the socket body.

FIG. 5 is a disassembled view of the present invention, showing the disassembled relation between the rotary disk and the socket body.

FIG. 6 is a sectional view of the present invention, showing the inner structure of the socket body.

FIG. 7 is a plan view of the present invention, showing the rotary disk rotated at an angle-1.

FIG. 8 is a plan view of the present invention, showing the rotary disk rotated at an angle-2.

### DETAILED DESCRIPTION OF THE PREFERRED EMBODIMENT

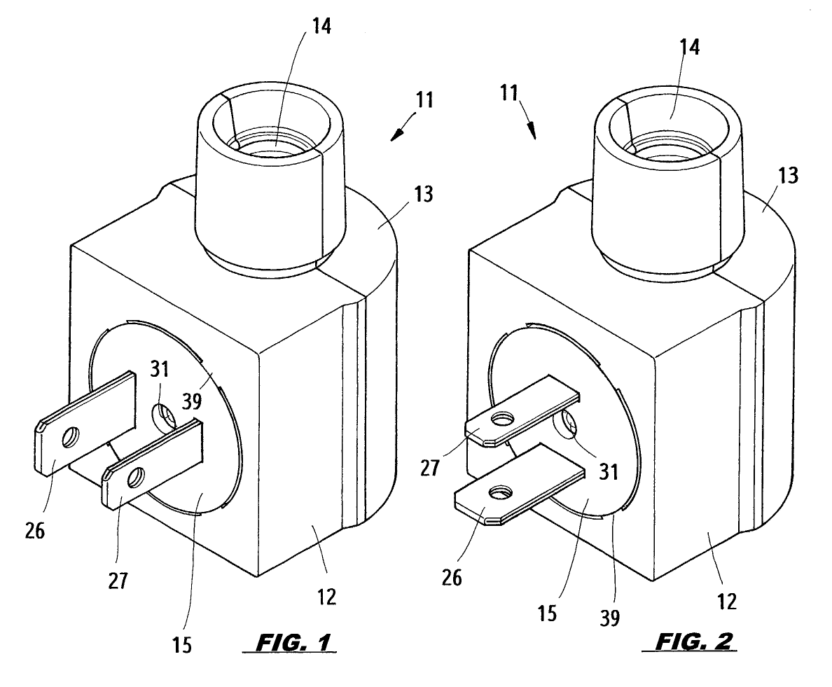

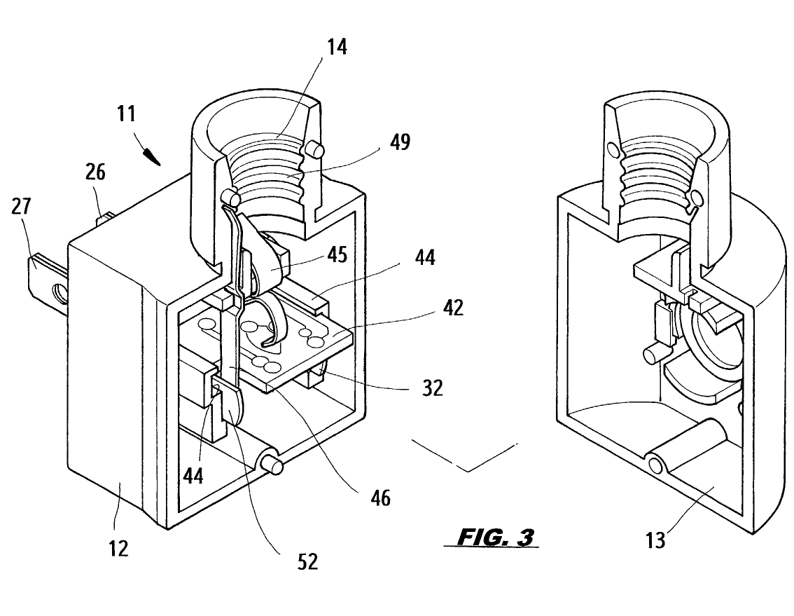

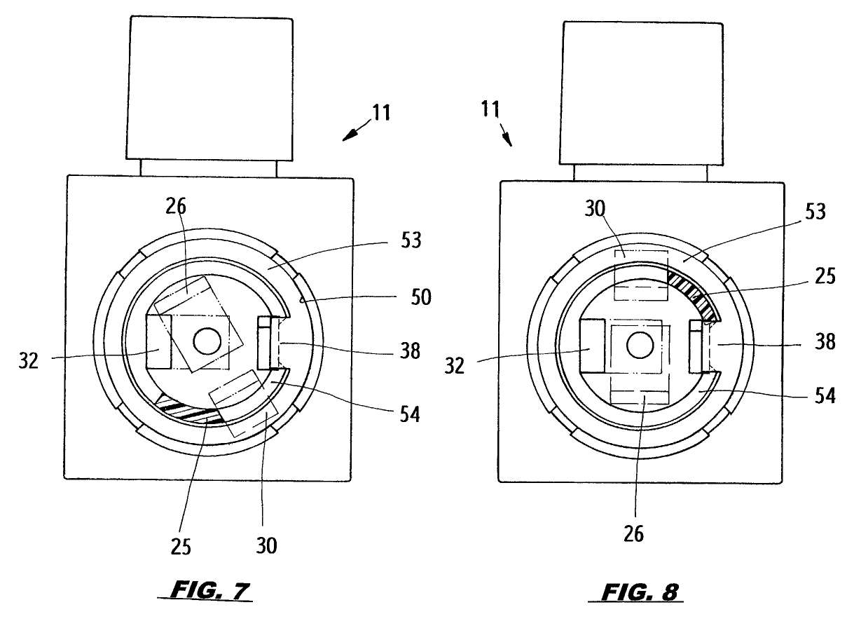

This invention relates to a rotary-plug wall lamp; as shown in FIGS. 1, 2, 7 and 8, the wall lamp 11 comprises a socket body 12, a socket casing 13, a socket 14 and two power copper pins 26 and 27; the power copper pins 26 and 27 are mounted on a rotary disk 15 which can rotate at angle of 270 degrees; the inner center of the rotary disk 15 has a hollow rivet 31 for holding a power copper pin 26 and a contact copper piece 32 together; another power copper pin 27 has a contact plate 30 to be in contact with a round contact plate 53 of a ring-shaped copper piece 33. When the rotary disk 15 is turned, the power copper pin 27 can maintain contact always with the round contact plate 53 so as to supply power to the wall lamp 11.

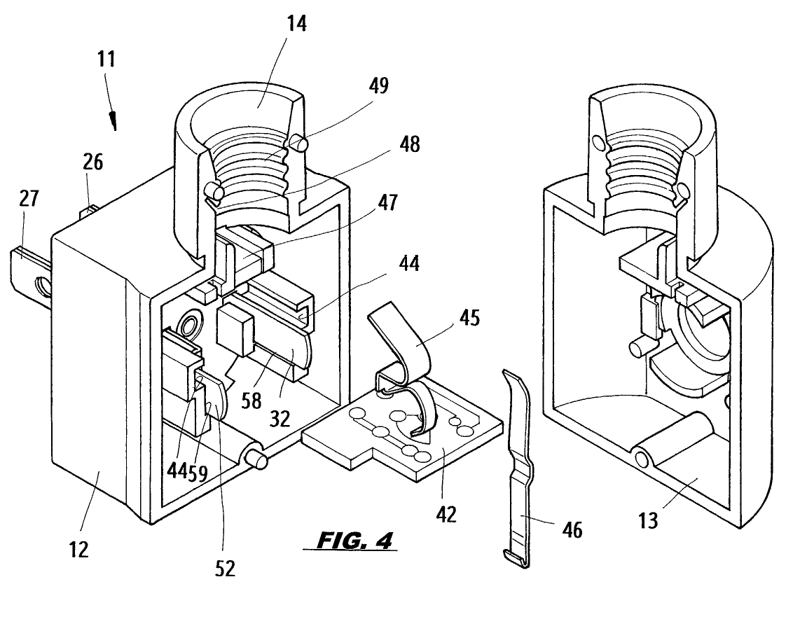

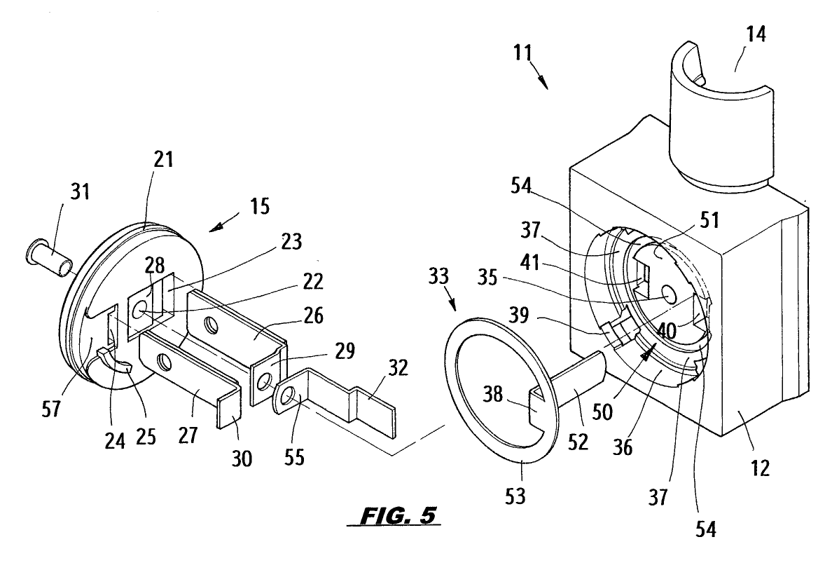

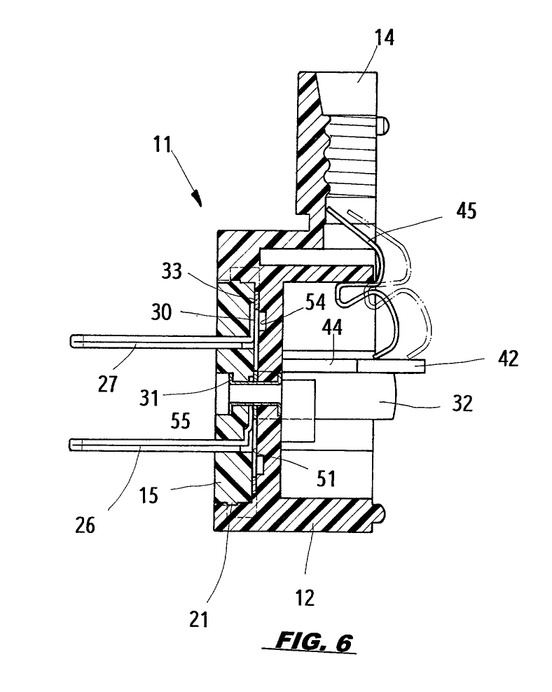

As shown in FIGS. 3 to 6, the body portion of the wall lamp 11 includes a socket body 12, a socket casing 13 and a rotary disk 15; the outer end of the socket body 12 has a seat hole 50, of which the wall surface 51 has a round hole 35; both sides of the round hole 35 are furnished with two rectangular holes 40 and 41 respectively; a guide channel 54 and a round channel 37 are furnished around the two rectangular holes 40 and 41. The opening of the seat hole 50 is furnished with a fastening flange 39; a round surface 36 is furnished under the fastening flange 39 for guiding the rotary disk 15 to move. The inside of the socket body 12 has a plug slot 44 for receiving a circuit board 42. The upper part thereof is furnished with copper piece seats 47 and 48 for plugging the bulb-contact copper pieces 45 and 46 respectively, and threads 49 for holding a bulb. The socket casing 13 is designed to fit the assembling structure of the socket body 12.

The rotary disk 15 is substantially a round board with a ring-shaped flange 21, which is designed to fit the round surface 36 of the seat hole 50 of the socket body 12; during assembling, the rotary disk 15 should be pressed so as to have the ring-shaped flange 21 passed through the fastening flange 39, and contacted closely with the round surface 36; i.e., the rotary disk 15 is limited to turn along the round surface 36 only. The outer surface of the rotary disk 15 is on the same level with the socket body. The center of the disk 15 has a round hole 22 and a rectangular hole 23 for receiving the power copper pin 26 to pass through; the power copper pin 26 has an angle plate 29 to be put in a recess 28 under the round hole 22; the angle plate 29 has a round hole to be aligned with the through round hole of the rotary disk 15 for receiving a hollow rivet 31, which is used for assembling the rotary disk 15, the power copper pin 26, the contact copper piece 32 and the wall surface 51 of the socket body 12 together as one unit. The power pin 26 and the contact copper piece 32 are connected together to fasten on the socket body 12 by means of a rivet 31 so as to have the power copper piece extended into the socket body 12.

The inner side of the rotary disk 15 is furnished with a through rectangular hole 24 and a recess surface 57; one side of the recess surface 57 has a curved positioning block 25. The rectangular hole 24 is used for receiving another power copper pin 27; the contact plate 30 of the power copper pin 27 is attached flatly on the recess surface 57. After the rotary disk 15 is mounted in the seat hole 50 of the socket body 12, the contact plate 30 will be in contact with the round contact plate 53 of the ring-shaped copper piece 33; the power copper pin can extend into the socket body 12 via the stop plate 38 and the flat plate 52.

The seat hole 50 of the socket body 12 is used for mounting the rotary disk 15, and the wall surface 51 of seat hole 50 has a through round hole 35; one side of the round hole has a rectangular hole 41 for receiving a contact copper piece 32 to plug into a fastening channel 58. The angle plate 55 of the contact copper piece 32 is attached flatly to the wall surface 51, and the center round hole of the angle plate 55 will be in alignment with the round hole 35 of the wall surface 51. When assembling, the contact copper piece 32 is mounted first in the rectangular hole 41 and the fastening channel 58; the power copper pin 26 and the rotary disk 15 have already assembled together; when the rotary disk 15 is mounted into the seat hole 50 of the socket body 12, the round hole 22 of the rotary disk 15, the round holes of the angle plate 29 and the angle plate 55 of the contact copper piece 32, and the round hole 35 of the seat hole 50 in the socket body 12 will be in alignment with one another so as to facilitate the hollow rivet 31 to pass through; after the hollow rivet 31 is riveted in place, the power copper pin 26 and the contact copper piece 32 will be fastened together to facilitate the rotary disk 15 to turn freely.

The wall surface 51 of the socket body 12 has another through rectangular hole 40, a guide channel 54 and a round channel 37; the rectangular hole 40 is used for receiving the flat plate 52 of the ring-shaped copper piece 33 to be plugged into a fastening channel 59 therein. The ring-shaped copper piece 33 includes the round contact plate 53, a stop plate 38 and a flat plate 52; the round contact plate 53 is substantially a round copper plate having a given width, and the inside thereof has a stop plate 38 to be bent into a flat plate 52, which is to be plugged into the rectangular hole 40 of the seat hole 50. The round contact plate 53 is laid in the round channel 37 on the edge of the wall surface 51; the stop plate 38 is laid horizontally over the guide channel 54. When the flat plate 52 of the ring-shaped copper piece 33 is plugged in place during assembling, the round contact plate 53 will be laid on the round channel 37, and then the stop plate 38 will be laid horizontally on the guide channel 54; the power copper pin 27 has been fastened together with the rotary disk 15; after the rotary disk 15 and the seat hole 50 of the socket body 12 are fastened together, the contact plate 30 of the power copper pin 27 will be in contact with the round contact plate 53 of the ring-shaped copper piece 33. After the hollow rivet 31 rivets the rotary disk 15 and the socket body 12 together, the contact plate 30 of the power copper pin 27 will maintain a given flexibility so as to have the round contact plate 53 of the ring-shaped copper pin 33 contacted closely with the contact plate 30 of the power copper pin 27; even if the rotary disk 15 is turned, the contact plate 30 and the round contact plate 53 will be maintained in close contact always.

A curved positioning block 25 on the inner surface of the rotary disk 15 will be placed into the guide channel 54 of the wall surface 51 in the seat hole 50 upon the rotary disk 15 and the seat hole 50 of the socket body 12 being fastened together. The positioning block 25 has a given length horizontally. When the stop plate 38 of the ring-shaped copper piece 33 is placed on the guide channel 54 horizontally, it will take a portion of the guide channel 54; when the rotary disk 15 is turned, the rotary disk 15 will be limited at a given angle as a result of the positioning block 25 hitting the stop plate 38 of the ring-shaped copper piece 33; in that case, the rotary disk 15 can turn freely only within an angle of 270 degrees.

The seat hole 50 of the socket body 12 is used for mounting the rotary disk 15; the two power copper pins 26 and 27 fastened to the rotary disk 15 each have an angle plate 29 and a contact plate 30 respectively, which are in close contact with the contact copper piece 32 and the ring-shaped copper piece 33 in the seat hole 50 of the socket body 12, and they can maintain better contact each other within the limited turning angle. The two copper pieces 32 and 33 are plugged in two fastening channels 58 and 59respectively, above which a plug slot 44 is furnished for mounting a circuit board 42. The circuit board 42 is in contact with the contact copper piece 32; through the contact point of the circuit board 42, the bulb-contact copper piece 45 can be in contact with the circuit board; the other end of the bulb-contact copper piece 45 is fastened to a copper piece seat 47. The ring-shaped copper piece 33 is not in contact with the contact point of the circuit board 42; one end of the bulb-contact copper piece 46 is hooked up with the tail end of the ring-shaped copper piece 33; the other end of the bulb-contact copper piece 46 is in contact with the copper piece seat 48. After the two bulb-contact copper pieces 45 and 46 are mounted in place, electric power can be supplied to the bulb through the power copper pin 26, and the threads 49 of the socket 14.

According to the aforesaid description on the connection structure between the socket body 12 and the rotary disk 15 in the embodiment, the wall lamp 11 can be turned freely within an angle of 270 degrees upon plugging in a power receptacle, and the contact points of the two power copper pins 26 and 27 will be in good contact condition so as to provide the bulb with power. The specification has disclosed the features and structure of the present invention completely; it is apparent that the present invention has provided a clear improvement, which is never anticipated and achieved by any person in the field, and therefore the structure of the present invention is deemed unique.

What is claimed is:

1. A rotary-plug wall lamp comprising a socket body having two fastening channels for plugging two contact copper pieces, a circuit board furnished above said fastening channels, and top side of said circuit board furnished with a contact point to be in contact with a bulb-contact copper piece; copper piece seats furnished between said socket body and a socket casing for receiving said two bulb-contact copper pieces so as to have power conducted to threads portion of socket; outer end of said socket body having a seat hole, in which a structure able to rotate at an angle of 270 degrees, including:
a seat hole of said socket body, of which bottom having a round hole, and two rectangular holes on both sides of said round hole; outer edge of said rectangular holes furnished with a guide channel and a round channel;
a contact copper piece having an angle plate at one end thereof, and said angle plate having a round hole; said contact copper piece passing through a rectangular hole at one side of said seat hole, and plugged in a fastening channel in said socket body and then said angle plate attached to said wall surface; said round hole of said angle plate aligned with a round hole of said wall surface;
a ring-shaped copper piece including a round contact plate, a stop plate and a flat plate; said round contact plate being substantially a ring-shaped copper plate having a given width, and inner side thereof furnished with said stop plate having an elongate flat plate; said flat plate plugged in one rectangular hole of said seat hole, and said round contact plate attached to a round channel of said wall surface, and said stop plate placed across said guide channel;
a rotary disk being substantially a round board, and center thereof having round hole and rectangular holes beside for receiving said power copper pins; a recess surface furnished beside one of said through rectangular hole;
a power copper pin, and inner end thereof having an angle plate with a round hole; flat part of said power copper pin plugged in said rectangular hole, and said angle plate attached to a round hole;
a hollow rivet passed through said rotary disk, said power copper pin, said contact copper piece and a round hole of said wall surface of said socket body.

2. A rotary-plug wall lamp as claimed in claim 1, wherein opening end of said seat hole of said socket body is furnished with a fastening flange; outer edge of said rotary disk having a ring-shaped flange; after said ring-shaped flange of said rotary disk pressed to a round surface of said seat hole, said fastening flange of said seat hole held said rotary disk in place.

3. A rotary-plug wall lamp as claimed in claim 1, wherein a curved positioning block is furnished beside said rectangular hole of said rotary disk for plugging a power copper pin, and said positioning block to be placed in a guide channel of said wall surface in said seat hole of said socket body; said positioning block being used to limit a turning angle of said rotary disk upon said stop plate of said ring-shaped copper piece touched the same.
